(19) United States
(12) Patent Application Publication
(10) Pub. No.: US 2011/0018488 A1
(43) Pub. Date: Jan. 27, 2011

(54) FREQUENCY-CHANGING CONTROL APPARATUS

(76) Inventor: Chia-Hsuan LIN, Taichung (TW)

Correspondence Address: SINORICA, LLC, 2275 Research Blvd., Suite 500, ROCKVILLE, MD, 20850, US

(21) Appl. No.: 12/507,268

(22) Filed: Jul. 22, 2009

(51) Int. Cl. H02P 27/00

(52) U.S. Cl. 318/806

(57) ABSTRACT

A frequency-changing control apparatus includes a rectification circuit, a control circuit, and a frequency-changing driving circuit. The control circuit includes a microprocessor. The frequency-changing control apparatus has variable voltage variable frequency for driving a motor. A temperature detection unit and an alarm device are connected to the microprocessor. The temperature detection unit is able to detect the temperature of the circumstance and convert a temperature value into a signal to be transmitted to the microprocessor for generating an alarm effect via the alarm device so that the operator could know the time of maintenance beforehand, preventing the apparatus from stopping suddenly because of superheat. The present invention is able to decrease the reject rate, reduce the loss of material, and cut down the maintenance cost.

### BACKGROUND OF THE INVENTION

1. Field of the Invention

The present invention relates to a frequency-changing control apparatus, and more particularly to a frequency-changing control apparatus having a superheat alarm effect.

2. Description of the Prior Art

Nowadays, the demand for automation control is increasing. A frequency-changing control apparatus having variable voltage variable frequency is in wide use, in particular to the control for driving a motor. A conventional frequency-changing control apparatus comprises a rectification circuit, a control circuit, and a frequency-changing driving circuit for controlling frequency-changing. The control circuit is further connected with a protective circuit to stop the apparatus when the temperature is overheated. Thereby, the frequency-changing control apparatus will cut off the power supply when the apparatus doesn't radiate well or overload, preventing the frequency-changing control apparatus from damage because of superheat. However, the sudden stopping will cause a serious loss to the production line, such as increasing the reject rate, the loss of material, and the defective rate. It is necessary to inspect the operation of the apparatus all the time, which increases the cost of maintenance. Accordingly, the inventor of the present invention has devoted himself based on his many years of practical experiences to the development of an improved frequency-changing control apparatus.

### SUMMARY OF THE INVENTION

A frequency-changing control apparatus includes a rectification circuit, a control circuit, and a frequency-changing driving circuit. The control circuit includes a microprocessor. The frequency-changing control apparatus has variable voltage variable frequency for driving a motor. A temperature detection unit and an alarm device are connected to the microprocessor. The temperature detection unit is able to detect the temperature of the circumstance and convert a temperature value into a signal to be transmitted to the microprocessor for generating an alarm effect via the alarm device so that the operator could know the time of maintenance beforehand, preventing the apparatus from stopping suddenly because of superheat. The present invention is able to decrease the reject rate, reduce the loss of material, lower the defective rate, and cut down the maintenance cost. The frequency-changing control apparatus is applied to a server control frequency convertor, a soft starter, or a frequency convertor in common use.

### BRIEF DESCRIPTION OF THE DRAWINGS

FIG. 1 is a circuit block diagram according to a first preferred embodiment of the present invention; and

FIG. 2 is a circuit block diagram according to a second preferred embodiment of the present invention.

### DETAILED DESCRIPTION OF THE PREFERRED EMBODIMENTS

Embodiments of the present invention will now be described, by way of example only, with reference to the accompanying drawings.

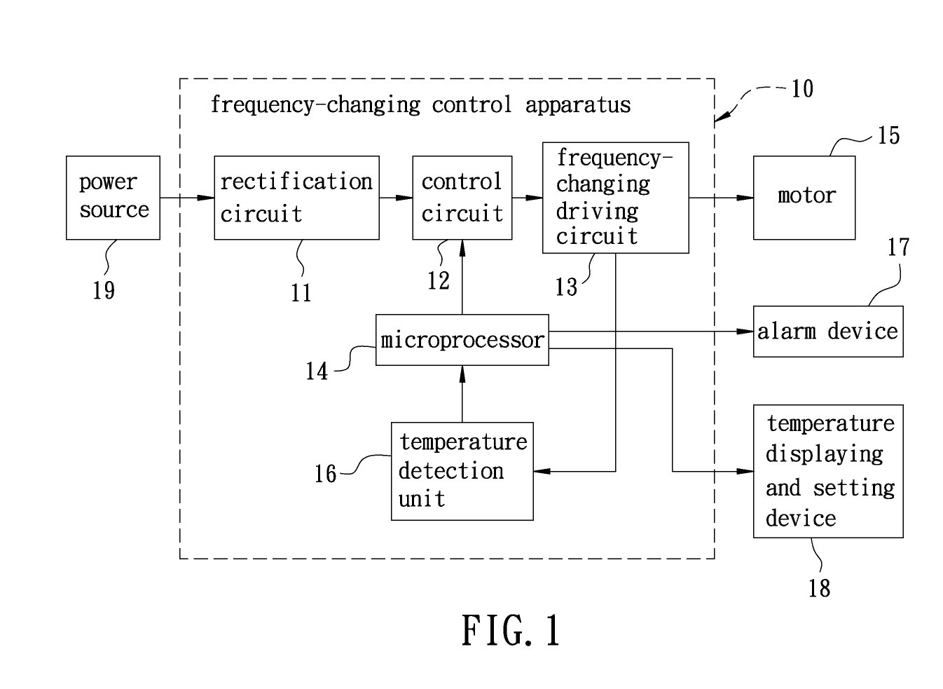

As shown in FIG. 1, a frequency-changing control apparatus 10 according to a first preferred embodiment of the present invention comprises a rectification circuit 11, a control circuit 12, and a frequency-changing driving circuit 13. The control circuit 12 comprises a microprocessor 14. The frequency-changing control apparatus 10 has variable voltage variable frequency for driving a motor 15. The present invention further comprises a temperature detection unit 16, an alarm device 17, and a temperature displaying and setting device 18.

The temperature detection unit 16 is connected to the microprocessor 14 of the control circuit 12 and mounted on a radiating fin of the frequency-changing driving circuit 13. In this embodiment, the temperature detection unit 16 is a positive temperature coefficient (PTC) thermister to detect the temperature of the radiating fin of the frequency-changing driving circuit 13 and convert the temperature value into a signal to be transmitted to the microprocessor 14. The temperature detection unit 16 has a predetermined temperature value less than an existing temperature valve for protecting circuit to stop the frequency-changing control apparatus 10.

The alarm device 17 is also connected to the microprocessor 14 of the control circuit 12. When the temperate value detected by the temperature detection unit 16 exceeds the predetermined temperature value, the alarm device 17 will send a signal to generate an alarm effect via the microprocessor 14. The alarm device 17 may be a warning light or a buzzer.

The temperature displaying and setting device 18 is connected to the microprocessor 14 to display the temperature detected by the temperature detection unit 16 and to set the predetermined temperature value.

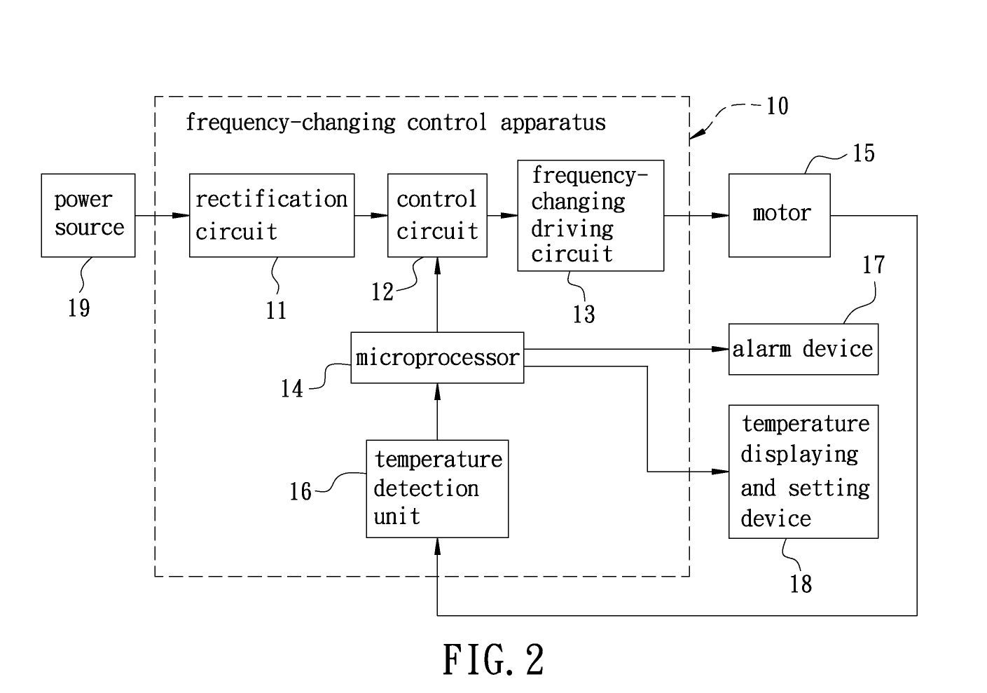

FIG. 2 is a second preferred embodiment of the present invention, which is substantially similar to the first preferred embodiment with the exceptions described hereinafter. The temperature detection unit 16 is connected to the microprocessor 14 of the control circuit 12 and mounted in the motor 15 such that the temperature detection unit 16 is able to detect the temperature of the motor 15 and convert the temperature value into a signal to be transmitted to the microprocessor 14.

When a power source 19 is started to operate the apparatus, the rectification circuit 11 will transmit the power source to the control circuit 12 and the frequency-changing driving circuit 13 for driving the motor 15 to work. The temperature detection unit 16 starts to detect the temperature of the circumstance and send a signal to the microprocessor 14. The temperature displaying and setting device 18 receives the signal from the microprocessor 14 so that the operator could know the detected temperature via the temperature displaying and setting device 18. When the temperature value detected by the temperature detection unit 16 exceeds the predetermined value, the microprocessor 14 will send a signal to the alarm device 17 for generating an alarm effect to remind the operator of maintaining the apparatus.

The frequency-changing control apparatus 10 of the present invention may be used to control a server control frequency convertor of an automatic control device, a soft starter, or a frequency convertor in common use.

The features and effects of the present invention are described as follows:

1. The temperature detection unit of the present invention is able to detect the temperature of the circumstance and convert the temperature value into a signal to be transmitted to the microprocessor for generating an alarm effect via the alarm device so that the operator could know the time of maintenance beforehand, preventing the apparatus from stopping suddenly because of superheat. Accordingly, the present invention is able to decrease the reject rate, reduce the loss of material, lower the defective rate, and cut down the maintenance cost.

2. The temperature displaying and setting device of the present invention is adapted to display the temperature value detected by the temperature detection unit so that the operator could know the temperature value at the moment and set the predetermined value according to the circumstance. This is convenient in use and is very practical.

3. The frequency-changing control apparatus of the present invention is applied to a server control frequency convertor, a soft starter, or a frequency convertor in common use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A frequency-changing control apparatus, comprising a rectification circuit, a control circuit, and a frequency-changing driving circuit, the control circuit comprising a microprocessor, the frequency-changing control apparatus having variable voltage variable frequency for driving a motor, and characterized by: the frequency-changing control apparatus further comprising a temperature detection unit and an alarm device:
the temperature detection unit being connected to the microprocessor of the control circuit, the temperature detection unit being adapted to detect a circumferential temperature and convert a temperature value into a signal to be transmitted to the microprocessor;
the alarm device being connected to the microprocessor of the control circuit, when the temperate value detected by the temperature detection unit exceeds a predetermined temperature value, the alarm device sending a signal to generate an alarm effect via the microprocessor.

2. The frequency-changing control apparatus as claimed in claim 1, further comprising a temperature displaying and setting device, the temperature displaying and setting device being connected to the microprocessor for displaying the temperature detected by the temperature detection unit.

3. The frequency-changing control apparatus as claimed in claim 1, wherein the temperature detection unit is a positive temperature coefficient (PTC) thermister.

4. The frequency-changing control apparatus as claimed in claim 1, wherein the temperature detection unit is mounted on a radiating fin of the frequency-changing driving circuit.

5. The frequency-changing control apparatus as claimed in claim 1, wherein the temperature detection unit is mounted in the motor.

6. The frequency-changing control apparatus as claimed in claim 1, wherein the alarm device is a warning light.

7. The frequency-changing control apparatus as claimed in claim 1, wherein the alarm device is a buzzer.

8. The frequency-changing control apparatus as claimed in claim 1, wherein the predetermined temperature value of the temperature detection unit is less than an existing temperature valve for protecting circuit to stop the frequency-changing control apparatus.
